(19) United States
(12) Patent Application Publication
(10) Pub. No.: US 2026/0212115 A1
(43) Pub. Date: Jul. 23, 2026

(54) GRAPH BASED DOCUMENT ALIGNMENT WITH LARGE LANGUAGE MODEL COMPARISON

(71) Applicant: Intuit Inc., Mountain View, CA (US)

(72) Inventors: Tharathorn RIMCHALA, San Francisco, CA (US); Pedro PONTE, Mountain View, CA (US); Jadiel DE ARMAS, Mountain View, CA (US)

(73) Assignee: Intuit Inc., Mountain View, CA (US)

(21) Appl. No.: 19/034,092

(22) Filed: Jan. 22, 2025

(51) Int. Cl. G06F 40/194; G06F 16/34; G06F 16/901

(52) U.S. Cl. CPC G06F 40/194; G06F 16/345; G06F 16/9024

(57) ABSTRACT

includes obtaining a document graph of a first document, and a document graph of a second document. The document graphs include a sequence of page entities and layout entities. The page entities and layout entities include comparison units. The operations further include processing the document graphs to identify at least one comparison unit of the second document graph as a changed comparison unit with respect to the first document graph and generating a prompt to a large language model (LLM) including changed comparison units as inputs and instructions to identify the inputs to be programmatically implemented as software code changes, and to generate a natural language change summary of the identified inputs. The operations further include displaying, in a web interface of a document comparison application, the changed comparison units, and natural language change summary obtained from the LLM.

### BACKGROUND

A vast number of software services and products are designed and developed to manage diverse aspects of a business or individual's professional or personal matters, such as finance, taxation, payroll, operations, inventory, regulatory compliance etc. Certain domains may undergo revisions to rules and codes frequently. Accordingly, the software services and products related to these domains may need to incorporate these revisions with corresponding software code changes. The effort and time expended in affecting the revised versions of the software services and products is largely manual.

Generative artificial intelligence models, such as large language models, may be leveraged to improve the effort and time expended in software code revisions of these software services and products at scale with high accuracy. However, when large documents containing numerous rule revisions and codes (for example, from a previous year and a current year) are input to commercial large language models (LLMs), the limited context windows of the LLMs may cause the output to include numerous false positives and hallucinatory comparisons. A further challenge exists when sections of a document span across pages. Commercial LLMs are not trained to comprehend a notion of page and reading order. Another challenge may arise when there is a lack of a one-to-one correspondence between the sections of the multiple documents.

### SUMMARY

In general, in one aspect, one or more embodiments include a method. The method includes obtaining a first document graph of a first document. The first document graph includes a sequence of a first set of page entities and a first set of layout entities. The first set of page entities and first set of layout entities include first comparison units. The method further includes obtaining a second document graph corresponding to a second document. The second document graph includes a sequence of a second set of page entities and a second set of layout entities. The second set of page entities and the second set of layout entities include second comparison units. The method further includes processing the first and second document graphs to identify at least one comparison unit of the second comparison units of the second document graph as a changed comparison unit with respect to the first comparison units of the first document graph to obtain changed comparison units of the second document graph. The method further includes generating a prompt to a large language model (LLM). The generated prompt includes the changed comparison units as inputs. The generated prompt further includes a first instruction to identify the inputs to be programmatically implemented as software code changes. The generated prompt further includes a second instruction to generate a natural language change summary of the identified prompt inputs. The method further includes displaying, in a web interface of a document comparison application, the changed comparison units, and the natural language change summary obtained from the LLM.

In general, in one aspect, one or more embodiments include a system. The system includes at least one computer processor, a document comparison application, including a web interface, and executing on the at least one computer processor, and a large language model (LLM), executing on the at least one computer processor. The system further includes a document comparison engine, including a document alignment tool and a prompt generator, executing on the at least one computer processor. The document comparison engine is configured to obtain a first document graph corresponding to a first document, including a sequence of a first set of page entities and a first set of layout entities. The first set of page entities and the first set of layout entities include first comparison units. The document comparison engine is further configured to obtain a second document graph corresponding to a second document, including a sequence of a second set of page entities and a second set of layout entities. The second set of page entities and the second set of layout entities include second comparison units. The document comparison engine is further configured to process the first and second document graphs by the document alignment tool. The document alignment tool is configured to identify at least one comparison unit of the second comparison units of the second document graph as a changed comparison unit with respect to the first comparison units of the first document graph to obtain changed comparison units of the second document graph. The prompt generator of the document comparison engine is configured to generate a prompt to the LLM. The generated prompt includes the changed comparison units as inputs. The generated prompt further includes a first instruction to identify the inputs to be programmatically implemented as software code changes. The generated prompt further includes a second instruction to generate a natural language change summary of the identified prompt inputs. The method further includes displaying, in a web interface of a document comparison application, the changed comparison units, and the natural language change summary obtained from the LLM. The document comparison engine is further configured to cause the document comparison application to display, in the web interface of the document comparison application, the changed comparison units and the natural language change summary obtained from the LLM.

In general, in one aspect, one or more embodiments include a method. The method includes obtaining a first document graph of a first document and a second document graph of a second document. The first document graph includes a first set of comparison units. The second document graph includes a second set of comparison units. The method further includes processing the first and second document graphs. Processing includes selecting a distance metric for determining a match between two comparison units. Processing further includes computing an all-pairs distance matrix comprising distance metric values for each comparison unit of the first set of comparison units paired with each comparison unit of the second set of comparison units. Processing further includes performing a convolution operation on the all-pairs distance matrix. The method further includes processing the all-pairs distance matrix and the distance metric with a minimum bipartite matching function to obtain matches between the first set of comparison units and the second set of comparison units. The match between a first comparison unit and a second comparison unit is determined by a corresponding distance metric value being less than a distance metric threshold. The method further includes identifying at least one comparison unit of the second comparison units of the second document graph as a changed comparison unit with respect to the first comparison units of the first document graph, to obtain changed comparison units of the second document graph. The method further includes generating a prompt to a large language model (LLM). The generated prompt includes the changed comparison units as inputs. The generated prompt further includes a first instruction to identify the inputs to be programmatically implemented as software code changes. The generated prompt further includes a second instruction to generate a natural language change summary of the identified prompt inputs. The method further includes displaying, in a web interface of a document comparison application, the changed comparison units, and the natural language change summary obtained from the LLM.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method, in accordance with one or more embodiments.

FIG. 3 shows a flowchart of a method, in accordance with one or more embodiments.

FIG. 4 shows a flowchart of a method, in accordance with one or more embodiments.

FIG. 5 shows an example of determining a reading order of page and layout entities, in accordance with one or more embodiments.

FIG. 6 shows an example of comparison units identified as insertions, deletions, and swaps, in accordance with one or more embodiments.

FIG. 7 shows an example of matches, insertions, and swaps between two versions of a document, in accordance with one or more embodiments.

FIGS. 8A and 8B show a computing system, in accordance with one or more embodiments.

Like elements in the various figures are denoted by like reference numerals for consistency.

### DETAILED DESCRIPTION

One or more embodiments are directed to graph based document alignment with large language model comparison. The graph based document alignment includes document layout analysis and alignment of two documents, in which a second document is a newer version, or edition of a first document. The document layout analysis constructs graphs of document sections, which may span across page boundaries. Document sections are physically and logically distinct parts of a document (for example, headers, footers, paragraphs, forms, lists, etc.). The graphs are linearized sequences of document entities, which correspond to document sections. The content of the document entities is divided into the smallest semantically cohesive units, referred to as comparison units. Thus, a document graph may include a sequence of comparison units of document entities. The sequence is in a natural language reading order of the document entities.

The document graphs are processed by an alignment algorithm to match corresponding comparison units and identify mismatched comparison units of document sections across the entire document graph. The result of processing the document graphs by the alignment algorithm is the identification of a set of comparison units in the second document which are changed from the comparison units of the first document. The changed comparison units may be classified as insertions, deletions, and swaps of/from the second document with respect to the first document.

The changed comparison units may subsequently be provided as prompt input to an LLM for various processing tasks. One task may include generation of computer program source code that implements software code changes in the software service or product. For example, by processing two versions of a corresponding section of tax code, the LLM may generate a natural language change summary of the changes between the two versions. The LLM may further prompted to generate software code changes to update tax preparation software in accordance with the natural language summary of the changes between the two versions.

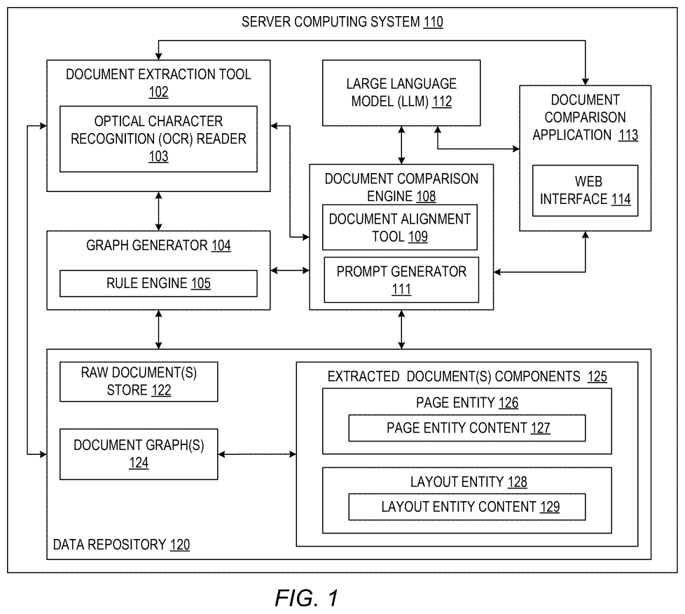

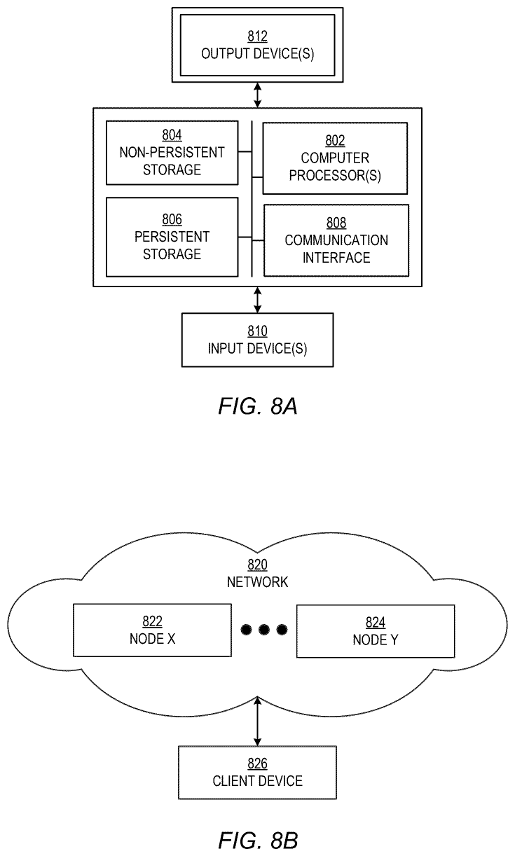

Attention is now turned to the figures. FIG. 1 shows a computing system, in accordance with one or more embodiments. The system shown in FIG. 1 includes a server computing system (110). The server computing system (110) is one or more computer processors, data repositories, communication devices, and supporting hardware and software. The server computing system (110) includes a computer processor. The computer processor is one or more hardware or virtual processors which may execute computer readable program code that defines one or more applications, such as the document extraction tool (102), the graph generator (104), the document comparison engine (108), the large language model (LLM) (112), and the document comparison application (113). The server computing system (110) may be in a distributed computing environment. An example of a computer system and network that may form the server computing system (110) is described with respect to FIG. 8A and FIG. 8B.

The system shown in FIG. 1 includes a data repository (120). The data repository (120) is a type of storage unit or device (e.g., a file system, database, data structure, or any other storage mechanism) for storing data. The data repository (120) may include multiple different, potentially heterogeneous, physical storage units and/or physical storage devices. The data repository (120) includes a raw document(s) store (122). The raw document(s) store (122) includes raw document(s) of an enterprise, related to various domains such as developer documentation, financial rules and regulations, tax rules and regulations, product information, etc. For example, the raw document(s) store (122) may include the documents that contain tax rules for filing federal and state taxes for a small business enterprise. The tax rules may include forms, form instructions, and details of calculation procedures. The tax rules may be used as a reference by developers to be programmatically implemented in software products and services of an enterprise, for example, tax filing applications, financial planning applications etc. The raw document(s) store (122) may be a document oriented database, e.g., MongoDB®, or a file system. In some embodiments, the raw document(s) store (122) may be a structured directory in cloud storage.

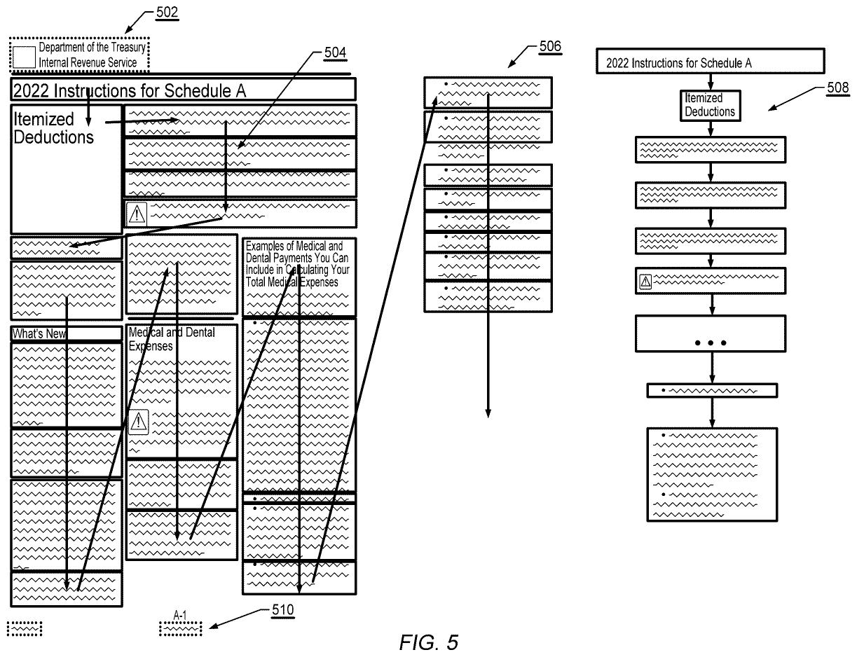

The data repository (120) further includes document graph(s) (124). The document graph(s) (124) are graph representations of the content of raw documents in order of the layout of the raw documents. A document graph (124) is a tree representation of ordered nodes and edges. The document graph (124) includes stored nodes connected by stored edges. Each node of the document graph(s) (124) stores individual comparison unit(s). In other words, an individual comparison unit may be identified as being stored a a particular node of the document graph (124). The edges of the document graph(s) (124) are connections between the nodes, such that traversing the graph along the edges yields a linearized sequence of nodes. In this manner, a linearized sequence of document content “chunks” or comparison units may be obtained from a document graph. More particularly, traversing the document graph through the nodes, and along the edges, traverses the comparison units of the nodes in a section-wise natural reading order of the document. A comparison unit is a smallest semantically cohesive unit of a particular section of a raw document. By way of example, in a paragraph, a comparison unit may be a sentence. In a form, the comparison unit may be a line item text of the form while another comparison unit may be a key-value pair of the line item. For example, a first comparison unit may be “Enter your name here” and another comparison unit may be Name_field-Name_value. In a list, the comparison unit may be a list entry. The sections of the raw document may themselves appear in the graph according to a natural reading order (e.g., top-down and left-right). An example of a document graph is described in detail in reference to FIG. 5. The document graph(s) (124) may be stored in a document oriented database such as MongoDB®, or as JavaScript Object Notation (JSON) files, or eXtended Markup Language (XML) files.

The data repository (120) further includes a store of extracted document components (125). The extracted document components (125) are the output of processing a raw document by the document extraction tool (102). The document extraction tool (102) may process a raw document to extract at least a page entity (126) and at least a layout entity (128).

A page entity (126) is for a document section that occurs on multiple pages of a document, such as headers and footers. A page entity (126) may include page entity content (127). The page entity content (127) may be repeated across multiple pages of a document within the section corresponding to the page entity (126) of the multiple pages. Additionally, the page entity content (127) may include information particular to a page.

For example, the pages of a document may include a header section. The header section may be extracted as a page entity. The page entity content of the header may include the document title, current year (calendar or financial), form number, etc. The pages of a document may further include a footer section. The footer section may be extracted as another page entity. The page entity content of the footer page entity may include page numbers that change for different pages of the document. The page entity content of the footer page entity may further include footnotes, which may differ across pages of the document. Additionally, the page entity content of the footer page entity may include information that is repeated across the pages of the document. An example of page entities and page entity content is described in detail in reference to FIG. 5.

A layout entity (128) corresponds to a content section of a raw document that is extracted by the document extraction tool (102). For example, in a tax form, a first section of a page in the tax form may include an introduction to the particular form (e.g., “2022 Instructions for Schedule A,” and “Itemized Deductions”), and some explanatory text (e.g., “Use Schedule A (Form 1040) to figure your itemized deductions. In most cases, your federal income will be less if . . . ”). The layout entity (128) accordingly may include layout entity content (129) as described in the above example. Multiple pages of a raw document may include multiple sections of various types. Some sections may span across multiple pages. The document extraction tool (102) may extract the layout entities (128) and the corresponding layout content (129) corresponding to the content sections of the raw document. The extracted document components (125) may be stored in various logical storage formats, for example, PostgreSQL®, MongoDB®, key-value stores such as Redis®, DynamoDB®, columnar databases such as Apache Cassandra®and HBase®, graph databases such as Neo4j®, etc.

The server computing system (110) further includes a document extraction tool (102). The document extraction tool (102) includes an optical character recognition (OCR) reader (103). The document extraction tool (102) is software or application-specific hardware, which, when executed by the computer processor, reads a raw document in image form, and extracts logical document entities and corresponding content, for example, page entities and page entity content and layout entities and layout entity content. The document extraction tool (102) includes the OCR reader (103) which reads the image form of the document content and extracts text, numbers, and other characters from the document image. The OCR reader (103) may further extract text from within certain artifacts such as pictorial images within the raw document, diagrams, charts, graphs, etc. The document extraction tool (102) may further classify and group the output of the OCR reader (103) into page entities and corresponding page content, and layout entities and corresponding layout content. Examples of document extraction tools include Tesseract®, Adobe Acrobat®Pro DC, Extracta.ai, Rossum®, DocSumo®, Nanonets®, DocParser®, Parseur®, etc.

The server computing system (110) further includes a graph generator (104). The graph generator (104) includes a rule engine (105) as a central computational engine. The graph generator (104) is software or application-specific hardware, which, when executed by the computer processor, generates a document graph of the raw document. The “nodes” of the document graph may include comparison units of the document, extracted by the rule engine (105). The “edges” of the document graph may connect the nodes in a tree structure, such that, when the graph is traversed through the nodes and along the edges, a linearized sequence of the nodes natural reading order may be obtained. In other words, traversing the document graph through the nodes along the edges is a traversal of the document content in natural reading order. The comparison units of the document may include information pertaining to their enclosing layout sections of the document. For example, a form “Form A” may be a particular section of a document. Form A may have instructions and key-value pairs. A first instruction may be “Enter your name.” The associated key-value pair may be “Name_field-John Doe.” These comparison units for Form A may further include the form name “Form A” when included as nodes of the document graph. Including the enclosing section information of a particular comparison unit within a document graph node may facilitate merging of the comparison units to the enclosing section in the post-processing steps of a document comparison.

The rule engine (105) of the graph generator (104) is software or application-specific hardware, which, when executed by the computer processor, processes the output of the document extraction tool (102), namely, the extracted document components (125) (of a raw document) to derive the correct ordering of the flow of text. The correct ordering of the flow of text may facilitate the derivation of the text sequence of the document. The rule engine (105) may classify the extracted document components (125) into page entities (126) and layout entities (128). Further, the rule engine (105) may perform a layout analysis of the layout entities and page entities, based on the rules of written natural language (e.g., English text flows in a top-to-bottom, left-to-right manner). Furthermore, the rule engine (105) may take into consideration more complex flow orders that may arise in multi-column documents, forms, tables, and figures. Additionally, the rule engine (105) may further split content of the page and layout entities into smallest semantically cohesive units, referred to as comparison units. The content of the page and layout entities may also be referred to layout content. Layout content may be dividable into comparison units. A smallest semantically cohesive unit of content in a page or layout entity may be defined as the smallest segment that conveys a complete and meaningful piece of information on its own. For example, in a form requesting personal details, the smallest semantically cohesive unit may be a single form instruction, or a form field with a label and a value (key-value pair). In one or more embodiments, the rule engine (105) may classify the comparison units into sentences, titles, cells of tables, key-value pairs, list items, form instructions, header fields, footer fields, etc. The graph generator (104) may use the output of the rule engine (105) to construct a document graph (124) of the extracted document components (125) of the raw document.

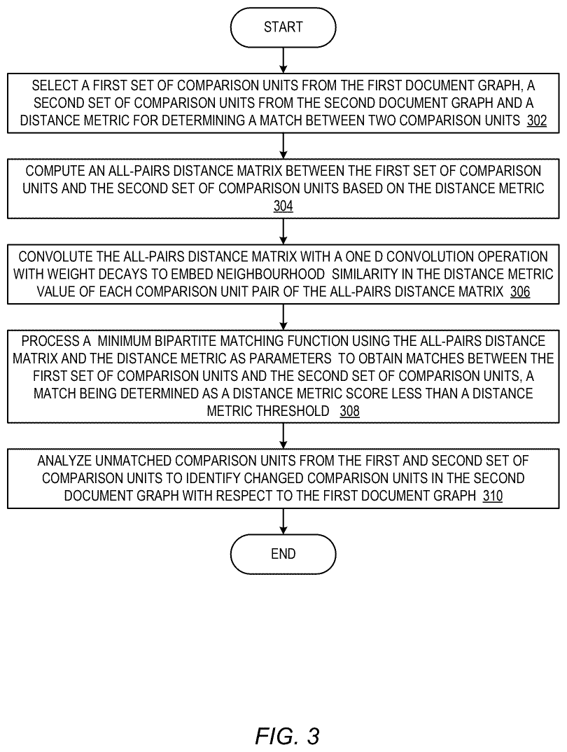

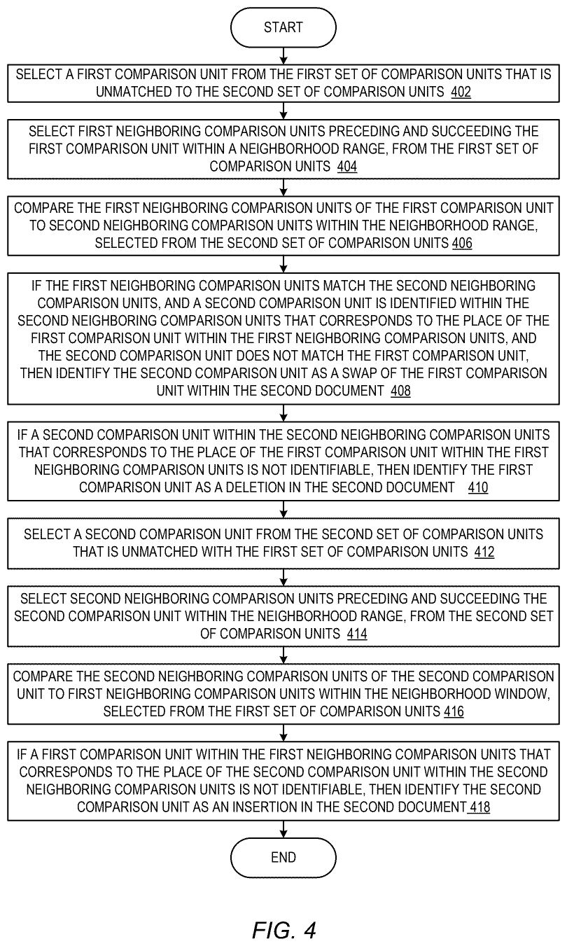

The server computing system (110) further includes a document comparison engine (108). The document comparison engine (108) includes a document alignment tool (109) and a prompt generator (111). The document comparison engine (108) is software or application-specific hardware, which, when executed by the computer processor, controls and coordinates operation of the software or application-specific hardware described herein. In other words, the document comparison engine (108) may control and coordinate the execution of the document extraction tool (102), the graph generator (104) the LLM (112), and the document comparison application (113). The document alignment tool (109) included in the document comparison engine (108) is a central computational component, which essentially performs the methods of FIG. 3 and FIG. 4. That is, the document alignment tool (109) compares a first document and a second document. The document alignment tool (109) identifies document changes in the second document with respect to the first document. A document change may be an insertion, referring to content that appears in the second document which is not found in the first document. A document change may further be a deletion, referring to content of the first document which does not appear in the second document. A document change may further be a swap, referring to content in the second document replacing content in the first document within a context of an ordered content sequence. The document alignment tool (109) may use document graphs of the first and second document to perform the comparison operations and analysis. The document change may correspond to a changed comparison unit in the document graph of the first and/or second document.

The prompt generator (111) of the document comparison engine (108) takes the output of the document alignment tool (109) and generates a machine-generated prompt to the LLM (112). The prompt generator (111) may provide the changed comparison units obtained from the document alignment tool (109) as prompt input. The prompt generator (111) may further add a first instruction to the LLM (112) to generate a natural language summary of the changed comparison units and classify which of the prompt inputs (i.e., the changed comparison units) may require a software code change. In one or more embodiments, the prompt generator (111) may be an LLM agent. LLM agents are components that leverage LLMs as a central computational engine. LLM agents may invoke LLMs programmatically, using prompt-engineering techniques such as “Chain-of-thoughts” and “Tree-of-thoughts” to decompose tasks and plan actions.

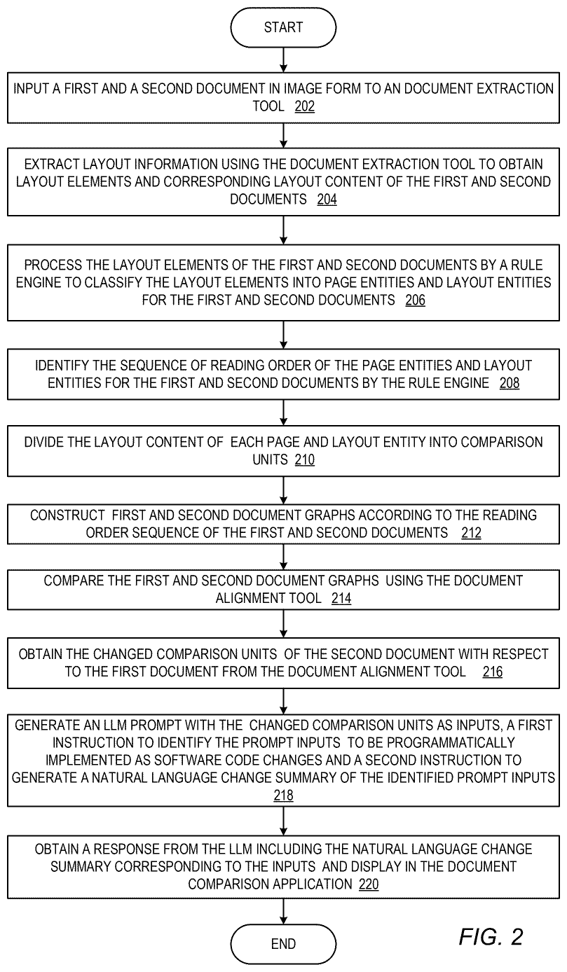

The server computing system (110) also includes an LLM (112). The LLM (112) is a natural language processing machine learning model. An example of the LLM (112) may be CHATGPT®. However, many different language models may be used. Use of the LLM (112) is described with respect to FIG. 2.

The server computing system (110) further includes a document comparison application (113). The document comparison application (113) is software or application-specific hardware, which when executed by the computer processor, essentially performs the method of FIG. 2. That is, the document comparison application (113) may include features exposed through the web interface (114) that facilitate a software developer or other user to compare a first and a second document. The comparison results may include changes that may require software code changes to enterprise applications or product line applications. In one embodiment of a workflow, the document comparison application (113) may initiate the document comparison engine (108), which in turn, may orchestrate the document extraction tool (102) and the graph generator (104) to obtain document graphs of the two documents. The document graphs may further be processed by the document alignment tool (109) to identify changed comparison units between the two documents. The prompt generator (111) may generate a prompt to the LLM (112) to classify the changed comparison units. Further, the LLM (112) may process the prompt to generate a response which may be displayed on the web interface (114) of the document comparison application (113). The response may include the natural language summary of changes, and classification of the changes into whether code changes are needed based on the changed comparison units.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for constructing document graphs for a first and second document for processing by the document alignment tool to identify changes in the second document with respect to the first document and provide a natural language change summary of the changes in the second document with respect to the first document. Further, the flowchart shown in FIG. 2 includes steps to classify the changes as warranting a software code change, in accordance with one or more embodiments. The method of FIG. 2 may be implemented using the system of FIG. 1 and one or more of the steps may be performed on or received at one or more computer processors. While the various steps in the flowchart shown in FIG. 2 are presented and described sequentially, at least some of the steps may be executed in different orders, may be combined, or omitted, and at least some of the steps may be executed in parallel. Furthermore, the steps may be performed actively or passively.

In Block 202, a first document and a second document in image form are inputted, that is, provided as input, to a document extraction tool. In Block 204, layout information and document content of the first and second documents are extracted using the document extraction tool to obtain layout elements and corresponding layout content of the first and second documents. In one or more embodiments, the document extraction tool may extract first layout elements of the first document. Further, the document extraction tool may extract the second layout elements of the second document. Layout elements refer to extracted document components, for example, the extracted document components (125) shown in the system of FIG. 1. The extracted document components include corresponding content (for example, a page entity is a (type of) layout element and includes page entity content). Thus, the layout elements include corresponding layout content. Further, the first layout elements refer to the extracted document components of the first document. Likewise, the second layout elements refer to the extracted document components of the second document.

In Block 206, the layout elements of the first and second documents are processed by a rule engine to classify the layout elements into page entities and layout entities for the first and second documents. In one or more embodiments, first layout elements corresponding to the first document, and second layout elements corresponding to the second document may be obtained. Further, the first layout elements may be classified by the rule engine into one of a page entity and a layout entity. As a result, the first set of page entities and the first set of layout entities for the first layout elements may be obtained. Likewise, the rule engine may classify the second layout elements into one of a page entity and a layout entity. In a similar manner, the second set of page entities and the second set of layout entities for the second layout elements may be obtained.

In Block 208, the sequence of reading order of the page entities and layout entities for the first and second documents by the rule engine is identified. In one or more embodiments, the reading order of the first set of page entities and the first set of layout entities corresponding to the first document may be determined by the rule engine, as the first reading order. In a similar manner, the reading order of the second set of page entities and the second set of layout entities corresponding to the second document may be determined by the rule engine, as the second reading order.

In Block 210, the layout content of each page and layout entity is divided into comparison units. In one or more embodiments, the layout content of each of the first and second set of page entities, and each of the first and second set of layout entities may be divided into comparison units. In one or more embodiments, each comparison unit of a page or layout entity may further include information related to the “parent” or enclosing entity within which the comparison unit appears. For example, if a layout entity of the first document is a form, and one comparison unit of the form is a form instruction, then the comparison unit may also include an identifier of the enclosing form within which the comparison unit appears. This additional information may be included with the comparison unit when the comparison unit is incorporated as a node into the first document graph. In this way, a comparison unit of a document may be tracked to a node in the document graph.

In Block 212, first and second document graphs are constructed, according to the reading order sequence of the first and second documents. In one or more embodiments, the first document graph may be constructed, corresponding to the first document. The first document graph may include the sequence of the first set of page entities and first set of layout entities in the first reading order. More specifically, the first document graph may include a sequence of nodes. The nodes may include comparison units. The sequence of nodes, or comparison units, in the graph follows the reading order of the first page entities and first layout entities of the first document. Stated another way, the reading order includes the reading order of the first layout elements of the first document. For example, if a first page entity is the header of the first page in the first document, and a first layout entity following the page entity is a form titled “Itemized deductions,” then the first document graph may include the comparison units of the first page entity in reading order, namely, the entries of the header in natural reading order. This sequence of comparison units of the first page entity (corresponding to the header) may be followed by a sequence of comparison units corresponding to the first layout entity in reading order, namely, the form, titled “Itemized deductions.” Thus, the document graph may include nodes in the following manner {“Department of the Treasury”; “Internal Revenue Service”; “2022 Instructions for Schedule A”; “Itemized Deductions”; “Use Schedule A (Form 1040) to figure your itemized deductions”; “In most cases, your federal income will be less if you take the larger of your itemized deduction or your standard deduction” . . . }. In a similar manner, the second document graph corresponding to the second document may be constructed. The second document graph may include a sequence of (comparison units of the) second set of page entities and the second set of layout entities in the second reading order.

In Block 214, the first and second document graphs are processed using the document alignment tool. In one or more embodiments, the first and second document graphs may be processed by the document alignment tool to identify comparison units of the second document graph as changed comparison units with respect to the first document graph. The step(s) of Block 214 is described in further detail in reference to the method shown in FIG. 3. In Block 216, the changed comparison units of the second document with respect to the first document, (identified by performing the step(s) of Block 214), are obtained from the document alignment tool.

In Block 218, an LLM prompt is generated, with the changed comparison units as inputs, a first instruction to identify the prompt inputs to be programmatically implemented as software code changes and a second instruction to generate a natural language change summary of the identified prompt inputs. In one or more embodiments, a prompt to a large language model (LLM) may be generated by the prompt generator. The changed comparison units are added as inputs to the prompt by the prompt generator. The prompt generator may generate the prompt based on a prompt template. The prompt generator further may add a first instruction to identify the inputs to be programmatically implemented as software code changes. The prompt generator may further add a second instruction to generate a natural language change summary of the identified prompt inputs. In one or more embodiments, the prompt generator may generate a series of prompts in a Chain-of-thoughts technique, to achieve the outcome of obtaining a natural language change summary corresponding to the changes of the second document with respect to the first document. The generated prompt(s) is (are) sent to the LLM for processing.

In Block 220, a response from the LLM including the identified prompt inputs and natural language change summary corresponding to the identified prompt inputs may be obtained and displayed in the document comparison application. In one or more embodiments, the changed comparison units and the natural language change summary may be displayed in a web interface of a document comparison application. In one or more embodiments, the natural language change summary may further include a computer program source code obtained from the LLM.

FIG. 3 shows a flowchart of a method for matching comparison units of a first and a second document graph corresponding to a first and a second document by the document alignment tool to identify changes in the second document with respect to the first document. The method of FIG. 3 may be implemented using the system of FIG. 1 and one or more of the steps may be performed on or received at one or more computer processors. While the various steps in the flowchart shown in FIG. 3 are presented and described sequentially, at least some of the steps may be executed in different orders, may be combined, or omitted, and at least some of the steps may be executed in parallel. Furthermore, the steps may be performed actively or passively.

As a brief overview of the method of FIG. 3, an alignment is computed that minimizes the sum of the distances between matched comparison units across the two documents.

In Block 302, a first set of comparison units from the first document graph is selected. Likewise, a second set of comparison units from the second document graph is selected. Further, a distance metric for determining a match between two comparison units is selected. In one or more embodiments, the distance metric may be an edit distance between two comparison units. An edit distance may quantify how different two comparison units (for example, two sentences) are. Edit distances measure the minimum number of operations over characters required to transform a first comparison unit into a second comparison unit of two comparison units, the operations including insertions, deletions or swaps. In certain other embodiments, different distance metrics, for example, cosine similarity, Euclidean distance, Manhattan distance, etc., may be used as the distance metric.

In Block 304, an all-pairs distance matrix is computed between the first set of comparison units and the second set of comparison units based on the distance metric. In one or more embodiments, the all-pairs distance matrix may include distance metric values for each comparison unit of the first set of comparison units paired with each comparison unit of the second set of comparison units. In other words, a distance metric value may be computed for a first comparison unit from the first set of comparison units, and a second comparison unit from the second set of comparison units, by processing the first and second comparison units with the selected distance metric function. The distance metric value obtained from processing the distance metric function may be taken as the matrix element for the comparison unit pair of the first and second comparison units.

In Block 306, the all-pairs distance matrix is convolved with a 1-D convolution operation with weight decays to embed neighborhood similarity in the distance metric value of each comparison unit pair of the all-pairs distance matrix. Convolution of a matrix with a one-dimensional (1-D) convolution involves applying a 1-D filter (or kernel) to each row or column of the matrix. As a brief overview, a 1-D kernel (i.e., a small array of numbers) is selected. The kernel “slides” across each row of the matrix. At each position, the elements of the kernel are multiplied by the corresponding elements of the row at a particular position. The multiplication results of all element pairs are summed up to get the convolution result for that position. This operation is repeated for all the positions in the row. In one or more embodiments, a convolution operation may be performed on the all-pairs distance matrix. More specifically, the convolution operation may be performed with weight decays on the all-pairs distance matrix. The weight decays may be selected as the 1-D kernel. In one or more embodiments, a goal of performing the convolution operation may be to embed neighborhood similarity calculations into the all-pairs distance matrix by first computing the all-pairs distance matrix and subsequently, using the 1-D convolution with weight decays, as the entries of the matrix go farther from the center pair in the distance matrix.

A “neighborhood” of a given comparison unit in a document graph refers to a set of comparison units that precede and succeed the given comparison unit in the sequence of the document graph, within a neighborhood range. For example, a neighborhood range of three may define a neighborhood of a given comparison unit as the three preceding and three succeeding comparison units of the given comparison unit.

As a brief overview, using neighborhood similarity to compare comparison unit pairs captures the following two cases: In a first case, a comparison unit from a first document graph may be matched to multiple comparison units from a second document graph. In order to determine which instance of the comparison unit in the second document graph matches with the comparison unit from the first document graph, the neighborhoods of the instances of the comparison unit in the first document graph and the second document graph may additionally be compared. In a second case, a first comparison unit from the first document graph may not appear in the second document graph. However, the neighborhood of the first comparison unit in the first document graph may be highly similar to a neighborhood in the second document graph of a second comparison unit that does not appear in the first document graph. On account of similar neighborhoods in the first and second document graphs of the two comparison units being considered, an assumption may be made that the two non-matching comparison units from the first and second document graphs are “swaps.” That is, the second comparison unit from the second document graph has been “swapped” with the first comparison unit from the first document graph.

Accordingly, the convolution operation is added as a further step of processing the all-pairs distance matrix.

In Block 308, a minimum bipartite matching function is processed, using the all-pairs distance matrix and the distance metric as parameters to obtain matches between the first set of comparison units and the second set of comparison units. A match is determined as a distance metric score (value) less than a distance metric threshold. In one or more embodiments, the all-pairs distance matrix and the distance metric may be processed with a minimum bipartite matching function to obtain matches between the first set of comparison units and the second set of comparison units, wherein a match between a first comparison unit and a second comparison unit is determined by a corresponding distance metric value being less than a distance metric threshold. As a brief overview, the minimum bipartite matching function finds a match between two comparison units (nodes) such that the total cost (or distance) of the matched pairs is minimized. The minimum bipartite matching function may use algorithms such as the Hungarian algorithm or linear programming to process the parameters.

In Block 310, unmatched comparison units from the first and second set of comparison units may be analyzed to identify changed comparison units in the second document graph with respect to the first document graph. The steps of Block 310 are described in further detail in reference to the method of FIG. 4.

FIG. 4 shows a flowchart of a method for analyzing unmatched comparison units of first and second document graphs corresponding to a first and a second document by the document alignment tool to classify the unmatched comparison units as one of an insertion, a deletion, or a swap. Comparison units classified with the aforementioned classifications may be collectively referred to as “changed” comparison units. The method of FIG. 4 may be implemented using the system of FIG. 1 and one or more of the steps may be performed on or received at one or more computer processors. While the various steps in the flowchart shown in FIG. 4 are presented and described sequentially, at least some of the steps may be executed in different orders, may be combined, or omitted, and at least some of the steps may be executed in parallel. Furthermore, the steps may be performed actively or passively.

In Block 402, a first comparison unit from the first set of comparison units that is unmatched to the second set of comparison units is selected. In one or more embodiments, a first unmatched comparison unit may be selected from the first set of comparison units. The distance metric values of the first unmatched comparison unit paired with each comparison unit of the second set of comparison units may be greater than the distance metric threshold. In other words, the first unmatched comparison unit may not be similar enough to any of the second set of comparison units in the second document graph to be classified as a match.

In Block 404, first neighboring comparison units preceding and succeeding the first comparison unit within a neighborhood range are selected, from the first set of comparison units. In one or more embodiments, first neighboring comparison units preceding and succeeding the first unmatched comparison unit are selected within a neighborhood range, from the first set of comparison units. The neighborhood range may define the number of preceding and succeeding comparison units to be selected.

In Block 406, the first neighboring comparison units of the first comparison unit may be compared to second neighboring comparison units within the neighborhood range, selected from the second set of comparison units. In one or more embodiments, second neighboring comparison units may be selected from the second set of comparison units within the neighborhood range. In other words, the number of first neighboring comparison units may be the same as the number of second neighboring comparison units. Further, the first neighboring comparison units may be compared to the second neighboring comparison units. By way of example, a first set of comparison units may be {3, 7, 9, 6, 5, 1, 2} and a second set of comparison units may be {4, 7, 9, 8, 5, 1, 3}. The comparison unit 6 from the first set may be unmatched. A neighborhood range of 2 may be selected. The neighborhood comparison units of 6 may therefore be {7, 9, 5, 1}. In the second set of comparison units, neighborhood comparison units may be selected as {7, 9, 5, 1}. As the neighborhood comparison units match, it may be determined that 6 in the first set of comparison units has been swapped with 8 in the second set of comparison units.

In Block 408, a check of multiple conditions is performed. If:
(i) the first neighboring comparison units match the second neighboring comparison units, and
(ii) a second comparison unit is identified within the second neighboring comparison units that corresponds to the place of the first comparison unit within the first neighboring comparison units, and
(iii) the second comparison unit does not match the first comparison unit, then the second comparison unit is identified as a swap of the first comparison unit within the second document.

Accordingly, in one or more embodiments, the first condition may be checked if the first neighboring comparison units match the second neighboring comparison units. A second check may be to ascertain if a second comparison unit is identified in the second neighboring comparison units. The position of the second comparison unit in the second neighboring comparison units must correspond to the position of the first unmatched comparison unit in the first neighboring comparison units. Further, an additional check may be to ascertain that the second comparison unit does not match the first unmatched comparison unit. If these three checks are passed, the second comparison unit may be identified as a swap of the first unmatched comparison unit in the second document with respect to the first document.

In Block 410, if a second comparison unit within the second neighboring comparison units that corresponds to the place of the first comparison unit within the first neighboring comparison units is not identifiable, then the first comparison unit may be identified as a deletion in the second document. In one or more embodiments, a check is carried out to ascertain that the first neighboring comparison units match the second neighboring comparison units. Further, a second check is carried out to ascertain that a second comparison unit in the second neighboring comparison units, in a position corresponding to a position of the first unmatched comparison unit in the first neighboring comparison units, is not identifiable. If these two checks are passed the first unmatched comparison unit may be identified as a deletion in the second document with respect to the first document.

In Block 412, a second comparison unit from the second set of comparison units that is unmatched with the first set of comparison units may be selected. In Block 414, second neighboring comparison units preceding and succeeding the second comparison unit within the neighborhood window may be selected from the second set of comparison units.

In Block 416, the second neighboring comparison units of the second comparison unit may be compared to first neighboring comparison units within the neighborhood range, selected from the first set of comparison units.

In Block 418, if a first comparison unit within the first neighboring comparison units that corresponds to the place of the second comparison unit within the second neighboring comparison units is not identifiable, then the second comparison unit may be identified as an insertion in the second document. In one or more embodiments, a check is carried out to ascertain that the second neighboring comparison units match the first neighboring comparison units. Further, a second check is carried out to ascertain that a first comparison unit in the first neighboring comparison units, in a position corresponding to the position of the second comparison unit in the second neighboring comparison units, is not identifiable. If these two checks are passed, then the second unmatched comparison unit may be identified as an insertion in the second document with respect to the first document.

FIG. 5 shows an example of identifying a reading order of an income tax schedule including new rules and deductions that may be availed of in filing an individual federal tax return, in accordance with one or more embodiments. The reading order is the reading order of the layout elements of the page entities and layout entities of the document. FIG. 5 further shows an example of a document graph including nodes consisting of comparison units, and edges in accordance with the identified reading order of the tax schedule. The following example is for explanatory purposes only and not intended to limit the scope of one or more embodiments. Blocks 502 and 510 show page entities of a page of a tax instruction document, namely, the header and footer of the page of the instruction document. The page entities include information such as the federal government department, form and financial year, form reference numbers, etc. Block 504 shows the reading order sequence of the document represented by arrows. The reading order sequence may be determined by the rule engine of FIG. 1. Block 506 shows a list of medical and dental payments divided into single list items, i.e., comparison units (shown as zig-zag lines, representative of natural language text). Finally, Block 508 shows the linearized sequence of comparison units of the page entities and layout entities of the document.

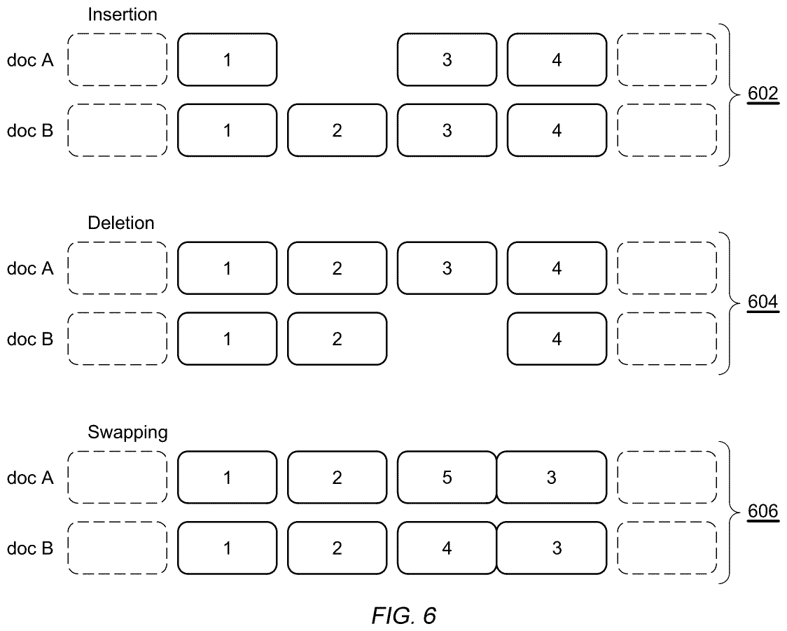

FIG. 6 shows a diagrammatic representation of identifying insertions, deletions, and swaps of a comparison unit within a neighborhood of comparison units. The following example is for explanatory purposes only and not intended to limit the scope of one or more embodiments.

Portion 602 shows a diagrammatic representation of an insertion in document B with respect to document A. The neighborhood of document A and document B includes the same sequence of comparison units. However, a comparison unit in document A, in the corresponding position of the comparison unit “2” in document B, is not identifiable. Thus, the comparison unit “2” is classified as a changed comparison unit, namely, an insertion in document B with respect to document A.

Portion 604 shows a diagrammatic representation of a deletion in document B with respect to document A. The neighborhood of document A and document B includes the same sequence of comparison units. However, a comparison unit in document B, in the corresponding position of the comparison unit “3” in document A, is not identifiable. Thus, the comparison unit “3” is classified as a changed comparison unit, namely, a deletion in document B with respect to document A.

Portion 606 shows a diagrammatic representation of a swap in document B with respect to document A. The neighborhood of document A and document B includes the same sequence of comparison units. However, a comparison unit “5” in document A, does not match comparison unit “4” in document B, in the corresponding position of comparison unit “5” in document A. Thus, the comparison unit “4” is classified as a changed comparison unit, namely, a swap in document B with respect to document A.

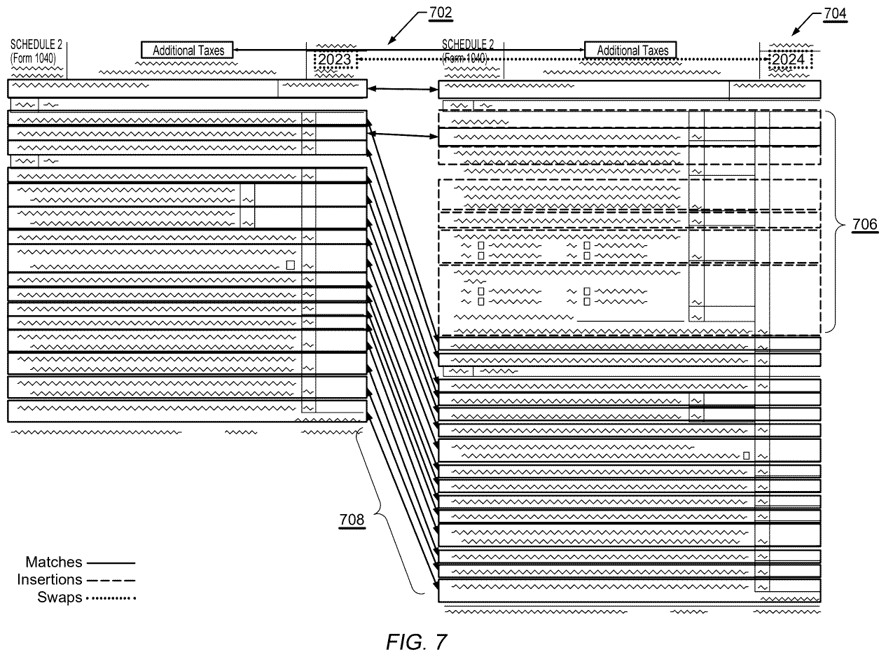

FIG. 7 shows a diagrammatic representation of identified matches, insertions, and swaps between a form in the tax year 2023, and a form in the tax year 2024. The following example is for explanatory purposes only and not intended to limit the scope of one or more embodiments. Blocks 702 and 704 show a swap (shown by boundary boxes with dotted lines) in which the number “4” has swapped out “3” in the financial year field. Portion 706 shows insertions (shown by boundary boxes with dashed lines) to the section “Part 1” in the 2024 form as compared to the “Part 1” section in the 2023 form. Portion 708 shows the matched comparison units (shown by boundary boxes with solid lines) between the 2023 form and the 2024 form. Notably, while the absolute sequence order of the matched comparison units is different, the matched comparison units are not misclassified as paired additions and deletions. Instead, the matched comparison units are “matched” based on the neighborhood similarity factor.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 8A, the computing system (800) may include one or more computer processor(s) (802), non-persistent storage device(s) (804), persistent storage device(s) (806), a communication interface (808) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) (802) may be one or more cores, or micro-cores, of a processor. The computer processor(s) (802) includes one or more processors. The computer processor(s) (802) may include a central processing unit (CPU), a graphics processing unit (GPU), a tensor processing unit (TPU), combinations thereof, etc.

The input device(s) (810) may include a touchscreen, keyboard, mouse, microphone, touchpad, electronic pen, or any other type of input device. The input device(s) (810) may receive inputs from a user that are responsive to data and messages presented by the output device(s) (812). The inputs may include text input, audio input, video input, etc., which may be processed and transmitted by the computing system (800) in accordance with one or more embodiments. The communication interface (808) may include an integrated circuit for connecting the computing system (800) to a network (not shown) (e.g., a local area network (LAN), a wide area network (WAN) such as the Internet, mobile network, or any other type of network) or to another device, such as another computing device, and combinations thereof.

Further, the output device(s) (812) may include a display device, a printer, external storage, or any other output device. One or more of the output device(s) (812) may be the same or different from the input device(s) (810). The input device(s) (810) and output device(s) (812) may be locally or remotely connected to the computer processor(s) (802). Many different types of computing systems exist, and the aforementioned input device(s) (810) and output device(s) (812) may take other forms. The output device(s) (812) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (802), is configured to perform one or more embodiments, which may include transmitting, receiving, presenting, and displaying data and messages described in the other figures of the disclosure.

The computing system (800) in FIG. 8A may be connected to, or be a part of, a network. For example, as shown in FIG. 8B, the network (820) may include multiple nodes (e.g., node X (822) and node Y (824), as well as extant intervening nodes between node X (822) and node Y (824)). Each node may correspond to a computing system, such as the computing system shown in FIG. 8A, or a group of nodes combined may correspond to the computing system shown in FIG. 8A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822) and node Y (824)) in the network (820) may be configured to provide services for a client device (826). The services may include receiving requests and transmitting responses to the client device (826). For example, the nodes may be part of a cloud computing system. The client device (826) may be a computing system, such as the computing system shown in FIG. 8A. Further, the client device (826) may include or perform all or a portion of one or more embodiments.

The computing system of FIG. 8A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a first document graph corresponding to a first document, including a sequence of a first set of page entities and a first set of layout entities wherein the first set of page entities and first set of layout entities include first comparison units;
obtaining a second document graph corresponding to a second document, including a sequence of a second set of page entities and a second set of layout entities, wherein the second set of page entities and the second set of layout entities include second comparison units;
processing the first and second document graphs to identify at least one comparison unit of the second comparison units of the second document graph as a changed comparison unit with respect to the first comparison units of the first document graph to obtain changed comparison units of the second document graph;
generating a prompt to a large language model (LLM) with:
the changed comparison units as inputs,
a first instruction to identify the inputs to be programmatically implemented as software code changes, to obtain identified prompt inputs and
a second instruction to generate a natural language change summary of the identified prompt inputs; and
displaying, in a web interface of a document comparison application, the changed comparison units, and the natural language change summary obtained from the LLM.

2. The method of claim 1, wherein the natural language change summary comprises a computer program source code obtained from the LLM.

3. The method of claim 1, further comprising:
obtaining first layout elements corresponding to the first document, and second layout elements corresponding to the second document, wherein a layout element includes a layout content;
classifying the first layout elements into one of a page entity and a layout entity to obtain the first set of page entities and the first set of layout entities for the first document graph; and
classifying the second layout elements into one of the page entity and the layout entity to obtain the second set of page entities and the second set of layout entities for the second document graph.

4. The method of claim 3, wherein the layout content includes at least one comparison unit comprising a smallest semantically cohesive unit of the layout content, and wherein the layout content is dividable into the at least one comparison unit.

5. The method of claim 1, further comprising:
inputting the first and second document to a document extraction tool, extracting, by the document extraction tool, first layout elements of the first document; and
extracting, by the document extraction tool, second layout elements of the second document.

6. The method of claim 1, further comprising:
determining a first reading order of the first set of page entities and the first set of layout entities corresponding to the first document;
determining a second reading order of the second set of page entities and the second set of layout entities corresponding to the second document;
dividing a layout content of each of the first set of page entities and the second set of page entities, and each of the first set of layout entities and the second set of layout entities into comparison units;
constructing the first document graph corresponding to the first document, including the sequence of the first set of page entities and the first set of layout entities in the first reading order, wherein the first set of page entities and the first set of layout entities include the first comparison units; and
constructing the second document graph corresponding to the second document, including the sequence of the second set of page entities and the second set of layout entities in the second reading order, wherein the second set of page entities and the second set of layout entities include second comparison units.

7. The method of claim 1, wherein processing the first and second document graphs further comprises:
selecting a first set of comparison units from the first document graph, and a second set of comparison units from the second document graph;
selecting a distance metric for determining a match between two comparison units;
computing an all-pairs distance matrix comprising distance metric values for each comparison unit of the first set of comparison units paired with each comparison unit of the second set of comparison units;
performing a convolution operation on the all-pairs distance matrix; and
processing the all-pairs distance matrix and the distance metric with a minimum bipartite matching function to obtain matches between the first set of comparison units and the second set of comparison units, wherein the match between a first comparison unit and a second comparison unit is determined by a corresponding distance metric value being less than a distance metric threshold.

8. The method of claim 7, further comprising:
selecting a first unmatched comparison unit from the first set of comparison units, wherein distance metric values of the first unmatched comparison unit paired with each comparison unit of the second set of comparison units are less than the distance metric threshold;
selecting first neighboring comparison units preceding and succeeding the first unmatched comparison unit within a neighborhood range, from the first set of comparison units;
comparing the first neighboring comparison units to second neighboring comparison units selected from the second set of comparison units within the neighborhood range;
responsive to the first neighboring comparison units matching the second neighboring comparison units, and
a second comparison unit being identified in the second neighboring comparison units, wherein a position of the second comparison unit in the second neighboring comparison units corresponds to a position of the first unmatched comparison unit in the first neighboring comparison units, and
the second comparison unit does not match the first unmatched comparison unit; and
identifying the second comparison unit as a swap of the first unmatched comparison unit in the second document with respect to the first document.

9. The method of claim 7, further comprising:
selecting a first unmatched comparison unit from the first set of comparison units;
selecting first neighboring comparison units preceding and succeeding the first unmatched comparison unit within a neighborhood range, from the first set of comparison units;
comparing the first neighboring comparison units to second neighboring comparison units selected from the second set of comparison units within the neighborhood range;
responsive to the first neighboring comparison units matching the second neighboring comparison units, and
a second comparison unit in the second neighboring comparison units, in a position in the second neighboring comparison units corresponding to a position of the first unmatched comparison unit in the first neighboring comparison units, not being identifiable; and
identifying the first unmatched comparison unit as a deletion in the second document with respect to the first document.

10. The method of claim 7, further comprising:
selecting a second unmatched comparison unit from the second set of comparison units;
selecting second neighboring comparison units preceding and succeeding the second unmatched comparison unit within a neighborhood range, from the second set of comparison units;
comparing the second neighboring comparison units to first neighboring comparison units selected from the first set of comparison units within the neighborhood range;
responsive to the second neighboring comparison units matching the first neighboring comparison units, and
a first comparison unit in the first neighboring comparison units, in a position in the first neighboring comparison units corresponding to a position of the second comparison unit in the second neighboring comparison units, not being identifiable; and
identifying the second unmatched comparison unit as an insertion in the second document with respect to the first document.

11. A system comprising:
at least one computer processor;
a document comparison application, including a web interface, and executing on the at least one computer processor;
a large language model (LLM), executing on the at least one computer processor; and
a document comparison engine, including a document alignment tool and a prompt generator, executing on the at least one computer processor and configured to:
obtain a first document graph corresponding to a first document, including a sequence of a first set of page entities and a first set of layout entities wherein the first set of page entities and the first set of layout entities include first comparison units;
obtain a second document graph corresponding to a second document, including a sequence of a second set of page entities and a second set of layout entities, wherein the second set of page entities and the second set of layout entities include second comparison units;
process the first and second document graphs by the document alignment tool to identify at least one comparison unit of the second comparison units of the second document graph as a changed comparison unit with respect to the first comparison units of the first document graph to obtain changed comparison units of the second document graph;
generating a prompt to the LLM by the prompt generator, with:
the changed comparison units as inputs,
a first instruction to identify the inputs to be programmatically implemented as software code changes, to obtain identified prompt inputs, and
a second instruction to generate a natural language change summary of the identified prompt inputs; and
cause the document comparison application to display, in the web interface of the document comparison application, the changed comparison units and the natural language change summary obtained from the LLM.

12. The system of claim 11, wherein the natural language change summary comprises a computer program source code obtained from the LLM, and further comprising:
a graph generator, including a rule engine, executing on the at least one computer processor and configured to:
obtain first layout elements corresponding to the first document, and second layout elements corresponding to the second document, wherein a layout element includes a layout content;
classify, by the rule engine, the first layout elements into one of a page entity and a layout entity to obtain the first set of page entities and the first set of layout entities for the first layout elements; and
classify, by the rule engine, the second layout elements into one of the page entity and the layout entity to obtain the second set of page entities and the second set of layout entities for the second layout elements.

13. The system of claim 11, further comprising:
a graph generator, including a rule engine, executing on the at least one computer processor and configured to:
determine, by the rule engine, a first reading order of the first set of page entities and the first set of layout entities corresponding to the first document;
determine, by the rule engine, a second reading order of the second set of page entities and the second set of layout entities corresponding to the second document;
divide, by the rule engine, a layout content of each of the first set of page entities and the second set of page entities, and each of the first set of layout entities and the second set of layout entities into comparison units;
construct the first document graph corresponding to the first document, including the sequence of the first set of page entities and the first set of layout entities in the first reading order, wherein the first set of page entities and the first set of layout entities include the first comparison units; and
construct the second document graph corresponding to the second document, including the sequence of the second set of page entities and the second set of layout entities in the second reading order, wherein the second set of page entities and the second set of layout entities include second comparison units.

14. The system of claim 11, wherein the document comparison engine is further configured to process the first and second document graphs by:
selecting, by the document alignment tool, a first set of comparison units from the first document graph, and a second set of comparison units from the second document graph,
selecting, by the document alignment tool, a distance metric for determining a match between two comparison units,
computing, by the document alignment tool, an all-pairs distance matrix comprising distance metric values for each comparison unit of the first set of comparison units paired with each comparison unit of the second set of comparison units,
performing, by the document alignment tool, a convolution operation on the all-pairs distance matrix, and
processing, by the document alignment tool, the all-pairs distance matrix, and the distance metric with a minimum bipartite matching function to obtain matches between the first set of comparison units and the second set of comparison units, wherein the match between a first comparison unit and a second comparison unit is determined by a corresponding distance metric value being less than a distance metric threshold.

15. The system of claim 14, wherein the document comparison engine is further configured to:
select, by the document alignment tool, a first unmatched comparison unit from the first set of comparison units, wherein distance metric values of the first unmatched comparison unit paired with each comparison unit of the second set of comparison units are less than the distance metric threshold;
select, by the document alignment tool, first neighboring comparison units preceding and succeeding the first unmatched comparison unit within a neighborhood range, from the first set of comparison units;
compare, by the document alignment tool, the first neighboring comparison units to second neighboring comparison units selected from the second set of comparison units within the neighborhood range;
responsive to the first neighboring comparison units matching the second neighboring comparison units, and
a second comparison unit being identified in the second neighboring comparison units, wherein a position of the second comparison unit in the second neighboring comparison units corresponds to a position of the first unmatched comparison unit in the first neighboring comparison units, and
the second comparison unit does not match the first unmatched comparison unit; and
identify, by the document alignment tool, the second comparison unit as a swap of the first unmatched comparison unit in the second document with respect to the first document.

16. The system of claim 14, wherein the document comparison engine is further configured to:
select, by the document alignment tool, a first unmatched comparison unit from the first set of comparison units;
select, by the document alignment tool, first neighboring comparison units preceding and succeeding the first unmatched comparison unit within a neighborhood range, from the first set of comparison units;
compare, by the document alignment tool, the first neighboring comparison units to second neighboring comparison units selected from the second set of comparison units within the neighborhood range;
responsive to the first neighboring comparison units matching the second neighboring comparison units, and
a second comparison unit in the second neighboring comparison units, in a position in the second neighboring comparison units corresponding to a position of the first unmatched comparison unit in the first neighboring comparison units, not being identifiable; and
identify, by the document alignment tool, the first unmatched comparison unit as a deletion in the second document with respect to the first document.

17. The system of claim 14, wherein the document comparison engine is further configured to:
select, by the document alignment tool, a second unmatched comparison unit from the second set of comparison units;
select, by the document alignment tool, second neighboring comparison units preceding and succeeding the second unmatched comparison unit within a neighborhood range, from the second set of comparison units;
compare, by the document alignment tool, the second neighboring comparison units to first neighboring comparison units selected from the first set of comparison units within the neighborhood range;
responsive to the second neighboring comparison units matching the first neighboring comparison units, and
a first comparison unit in the first neighboring comparison units, in a position in the first neighboring comparison units corresponding to a position of the second comparison unit in the second neighboring comparison units, not being identifiable; and
identify, by the document alignment tool, the second unmatched comparison unit as an insertion in the second document with respect to the first document.

18. A method, comprising:
obtaining a first document graph of a first document and a second document graph of a second document, wherein the first document graph includes a first set of comparison units, and the second document graph includes a second set of comparison units;
processing the first and second document graphs by:
selecting a distance metric for determining a match between two comparison units,
computing an all-pairs distance matrix comprising distance metric values for each comparison unit of the first set of comparison units paired with each comparison unit of the second set of comparison units,
performing a convolution operation on the all-pairs distance matrix, and
processing the all-pairs distance matrix and the distance metric with a minimum bipartite matching function to obtain matches between the first set of comparison units and the second set of comparison units, wherein the match between a first comparison unit and a second comparison unit is determined by a corresponding distance metric value being less than a distance metric threshold, and
identifying at least one comparison unit of the second comparison units of the second document graph as a changed comparison unit with respect to the first comparison units of the first document graph, to obtain changed comparison units of the second document graph;
generating a prompt to a large language model (LLM) with:
the changed comparison units as inputs,
a first instruction to identify the inputs to be programmatically implemented as software code changes, to obtain identified prompt inputs, and
a second instruction to generate a natural language change summary of the identified prompt inputs; and
displaying, in a web interface of a document comparison application, the changed comparison units, and the natural language change summary obtained from the LLM.

19. The method of claim 18, wherein the natural language change summary comprises a computer program source code obtained from the LLM, and further comprising:
selecting a first unmatched comparison unit from the first set of comparison units, wherein distance metric values of the first unmatched comparison unit paired with each comparison unit of the second set of comparison units are less than the distance metric threshold;
selecting first neighboring comparison units preceding and succeeding the first unmatched comparison unit within a neighborhood range, from the first set of comparison units; and
comparing the first neighboring comparison units to second neighboring comparison units selected from the second set of comparison units within the neighborhood range.

20. The method of claim 19, further comprising:
responsive to the first neighboring comparison units matching the second neighboring comparison units, and
a second comparison unit being identified in the second neighboring comparison units, wherein a position of the second comparison unit in the second neighboring comparison units corresponds to a position of the first unmatched comparison unit in the first neighboring comparison units, and
the second comparison unit does not match the first unmatched comparison unit,
identifying the second comparison unit as a swap of the first unmatched comparison unit in the second document with respect to the first document; and
responsive to the first neighboring comparison units matching the second neighboring comparison units, and
a second comparison unit in the second neighboring comparison units, in a position in the second neighboring comparison units corresponding to a position of the first unmatched comparison unit in the first neighboring comparison units, not being identifiable,
identifying the first unmatched comparison unit as a deletion in the second document with respect to the first document.
